(19) United States
(12) Patent Application Publication
(10) Pub. No.: US 2015/0123596 A1
(43) Pub. Date: May 7, 2015

(54) CHARGING DEVICE

(71) Applicant: Jiunn Yeh Electronic Co., Ltd., Tainan City (TW)

(72) Inventor: Ming-Hsien Hsieh, Tainan City (TW)

(73) Assignee: Jiunn Yeh Electronic Co., Ltd., Tainan City (TW)

(21) Appl. No.: 14/288,487

(22) Filed: May 28, 2014

(30) Foreign Application Priority Data
Nov. 4, 2013 (TW) 102220501

(51) Int. Cl. H02J 7/00

(52) U.S. Cl. CPC H02J 7/0052; H02J 7/0006
USPC 320/107

(57) ABSTRACT

A charging device for charging a storage battery includes a converter module which converts AC power into DC power, and a charging management module which includes a communication unit for data exchange with an external device, a DC charging unit for receiving the DC power, a processing unit receiving input charging data from the external device via the communication unit, and a memory unit storing preset charging data. The processing unit, based on one of the input charging data and the preset charging data, controls the DC charging unit to convert the DC power into a DC charging power that is used to charge the storage battery and that conforms with a charging characteristic of the storage battery.

### CROSS-REFERENCE TO RELATED APPLICATION

This application claims priority of Taiwanese Patent Application No. 102220501, filed on Nov. 4, 2013.

### BACKGROUND OF THE INVENTION

1. Field of the Invention

The invention relates to a charging device, snore particularly to a charging device capable of charging different kinds of storage batteries.

2. Description of the Related Art

A storage battery, also known, as a rechargeable battery, is widely applied in various kinds of equipments. There are many finds of storage batteries, such as a lithium battery, a lead-acid battery, a nickel-metal hydride battery and so forth. Different types of storage batteries may have distinct charging conditions. Moreover, even the same type of storage batteries may have different charging conditions when capacities of the storage batteries of the same type differ. For example, the charging conditions may be parameters, such as a charging voltage, a charging current or a charging temperature.

However, most battery chargers on the market are only capable of charging specific kinds of storage batteries, respectively. If a user owns many kinds of storage batteries, corresponding combers of battery chargers are required to charge the different storage batteries, resulting in inconvenience in usage and higher costs. Therefore, the design of a conventional battery charger is still expected to be improved.

### SUMMARY OF THE INVENTION

Therefore, an aspect of the present invention is to provide a charging device which is capable of adjusting a charging mode thereof according to a type and specifications of a storage battery to be charged.

In a first aspect, the charging device according to the present invention is to be connected electrically to an alternating-current (AC) power source and is configured to charge a storage battery. The charging device comprises a converter module and a charging management module. The converter module is to be connected electrically to the AC power source and converts an AC power received from the AC power source into a direct current (DC) power. The charging management module include a communication unit, a DC charging unit, a processing unit and a memory unit. The communication unit is configured for data exchange with an external device. The DC charging unit is connected electrically to the converter module for receiving the DC power, and is to be connected electrically to the storage battery. The processing unit is connected electrically to the communication unit and the DC charging unit, and receives input charging data from the external device via the communication unit. The memory unit is connected electrically to the processing unit and stores preset charging data. The input charging data and the preset charging data are associated with a charging characteristic of the storage battery. The processing unit, based on one of the input charging data and the preset charging data, controls the DC charging unit to convert the DC power received thereby into a DC charging power that is used to charge the storage battery and that conforms with the charging characteristic of the storage battery.

In a second aspect, the charging device according to the present invention is to be connected electrically to an AC power source and is configured to charge a storage battery. The charging device comprises a converter module and a charging management module. The converter module is to be connected electrically to the AC power source and converts an AC power received from the AC power source into a DC power. The charging management module includes a communication unit, a DC charging unit and a processing unit. The communication unit is configured for data exchange with an external device. The DC charging unit is connected electrically to the converter module for receiving the DC power, and is to foe connected electrically to the storage battery. The processing unit is connected electrically to the communication unit and the DC charging unit, and receives input charging data from the external device via the communication unit. The input charging data is associated with a charging characteristic of the storage battery. The processing unit, based on the input charging data, controls the DC charging unit to convert the DC power received thereby into a DC charging power that is used to charge the storage battery and that conforms with the charging characteristic of the storage battery.

In a third aspect, the charging device according to the present invention is to be connected electrically to an AC power source and is configured to charge a storage battery. The charging device comprises a converter module and a charging management module. The converter module is to be connected electrically to the AC power source and converts an AC power received from the AC power source into a DC power. The charging management module includes a DC charging unit, a processing unit and a memory unit. The DC charging unit is connected electrically to the converter module for receiving the DC power, and is to be connected electrically to the storage battery. The processing unit is connected electrically to the DC charging unit. The memory unit is connected electrically to the processing unit and stores preset charging data associated with a charging characteristic of the storage battery. The processing unit, based on the preset charging data, controls the DC charging unit to convert the DC power received thereby into a DC charging power that is used to charge the storage battery and that conforms with the charging characteristic of the storage battery.

An effect of the present invention resides in that, by means of the communication unit of the charging management module which receives the input charging data inputted via the external device, the processing unit, based on the input charging data, is able to control the DC charging unit to generate the DC charging power that is used to charge the storage battery and that conforms with the charging characteristic of the storage battery. In this way, the present invention is capable of charging different kinds of storage batteries with different specifications. Moreover, since the charging management module further includes the memory unit which stores the preset charging data that may serve as the input charging data, the charging device of the present invention is not required to be always connected to the external device for receiving the input charging data unless it is intended to update or add the preset charging data.

### BRIEF DESCRIPTION OF THE DRAWINGS

Other features and advantages of the present invention will become apparent in the following detailed description of a preferred embodiment with reference to the accompanying drawings, of which:

FIG. 1 is a schematic diagram of a preferred embodiment of a charging device according to the present invention;

FIG. 2 is a block diagram illustrating the preferred embodiment of the present invention; and

FIG. 3 and FIG. 4 are flow charts illustrating the preferred embodiment of the present invention.

### DETAILED DESCRIPTION OF THE PREFERRED EMBODIMENT

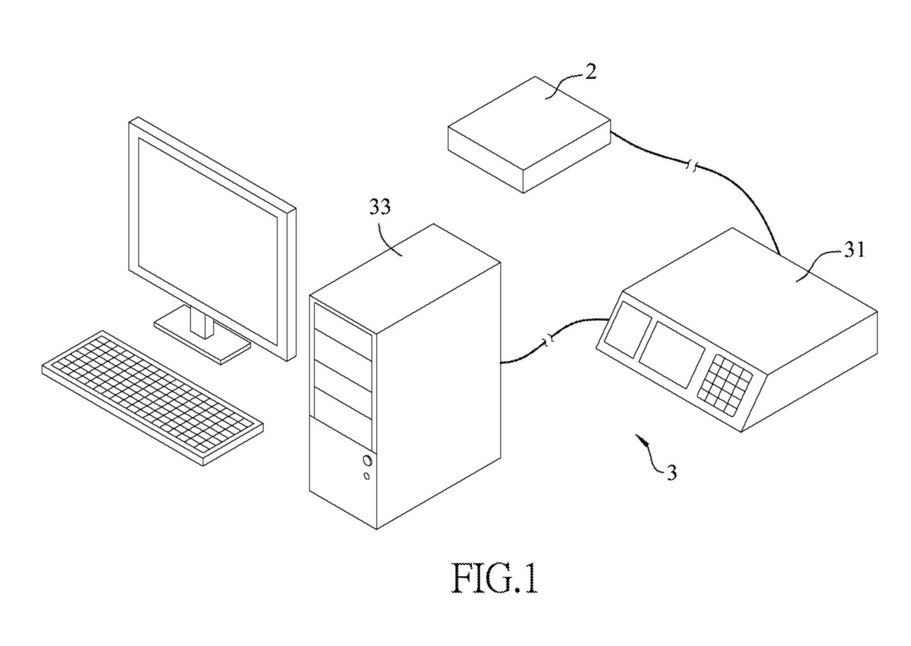

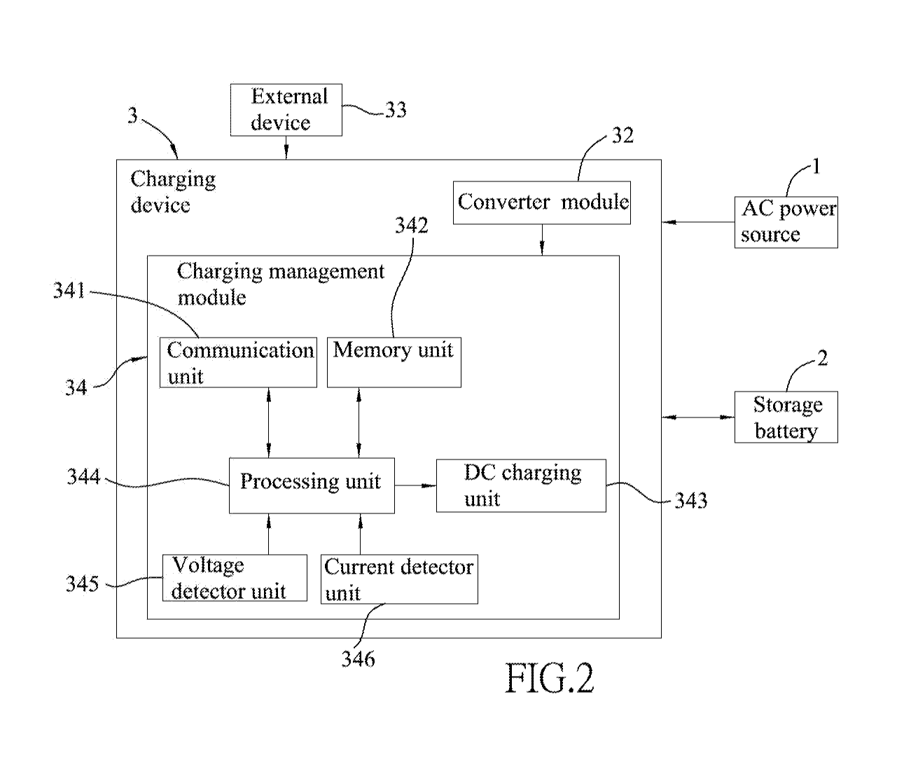

Referring to FIG. 1 and FIG. 2, a preferred embodiment of a charging device 3 according to the present invention is to be connected electrically to an alternating-current (AC) power source 1 (e.g., a commercial power), and is configured to charge a storage battery 2. In this embodiment, the AC power source 1 is able to provide an AC power having 85 Vac to 265 Vac at 50/60 Hz, and the storage battery 2 is a lithium battery. However, in practice, the storage battery 2 may be a lead-acid battery, a nickel-metal hydride battery, or any other rechargeable battery. Moreover, the capacity of the storage battery 2 is not limited. The charging device 3 comprises a casing 31, a converter module 32, and a charging management module 34, The charging device 3 is farther selectively connected to an external device 33 (e.g., a host computer).

The casing 31 is configured to house and protect electric circuits and electronic elements of the charging device 3, i.e., the converter module 32 and the charging management module 34. A shape and a structure of the casing 31 are not limited.

The converter module 32 of the preferred embodiment is to foe connected electrically to the AC power source 1 via an electric wire (not shown), and converts the AC power received from the AC power source 1 into a direct-current (DC) power. In this embodiment, the converter module 32 is an AC-to-DC converter, such as a bridge rectifier.

In the preferred embodiment, the external device 33 may be operated by a user for input of input charging data which are associated with a charging characteristic of the storage battery 2. The external device 33 is a personal computer in this embodiment but is not limited to the same in practice. For example, the external device 33 may be one of a smart phone, a tablet computer, and any device that is provided with an RS232 or USB port and that can be used for input of charging parameters, i.e., the input charging data.

The charging management module 34 is connected electrically to the converter module 32, and includes a communication unit 341, a memory unit 342, a DC charging unit 343 that is connected electrically to the converter module 32 for receiving the DC power and that is to be connected electrically to the storage battery 2, a processing unit 344 that is connected electrically to the communication unit 341, the memory unit 342 and the DC charging unit 343, a voltage detector unit 343 that is connected electrically to the processing unit 344 and the DC charging unit 343, and a current detector unit 346 that is connected electrically to the processing unit 344 and the DC charging unit 343.

The communication unit 341 is connected to the external device 33 by means of wired communication for data exchange with the external device 33. In this embodiment, the communication unit 341 is connected to the external device 33 via the RS232 communication protocol or the CAN (controller area network) bus communication protocol. However, in practice, the communication unit 341 is not limited to the disclosure herein, and may be one of a Bluetooth module, a WiFi module, or a 3G module for wireless communication with the external device 33.

The DC charging unit 343 is a DC/DC converter circuit, such as a Buck converter or a Buck-boost converter.

The voltage detector unit 345 is to be connected electrically to the storage battery 2 for detecting a voltage of the storage battery 2. The current detector unit 346 is to be connected electrically to the storage battery 2 for detecting a current of the storage battery 2.

The processing unit 344 receives the input charging data from the external device 33 via the communication unit 341. The memory unit 342 stores preset charging data which are associated with the charging characteristic of the storage battery 2. Preferably, the processing unit 344 is configured to store the input charging data received thereby in the memory unit 342 to serve as the preset charging data. The processing unit 344, based on one of the input charging data and the preset charging data, controls the DC charging unit 343 to convert the DC power received thereby into a DC charging power that is used to charge the storage battery 2 and that conforms with the charging characteristic of the storage battery 2. Preferably, the processing unit 344 makes a comparison between the voltage detected by the voltage detector unit 345 and said one of the input charging data and the preset charging data, and controls the DC charging unit 343 according to a result of the comparison made thereby. Alternatively, the processing unit 344 makes a comparison between the current detected by the current defector unit 346 and said one of the input charging data and the preset charging data, and controls the PC charging unit 343 according to a result of the comparison made thereby.

In an example of the preferred embodiment, a lithium battery having the capacity of 22 ampere-hour (Ah) is given as an example for explaining the storage battery 2 that is to be charged. Procedures of charging the storage battery 2 are described hereinafter.

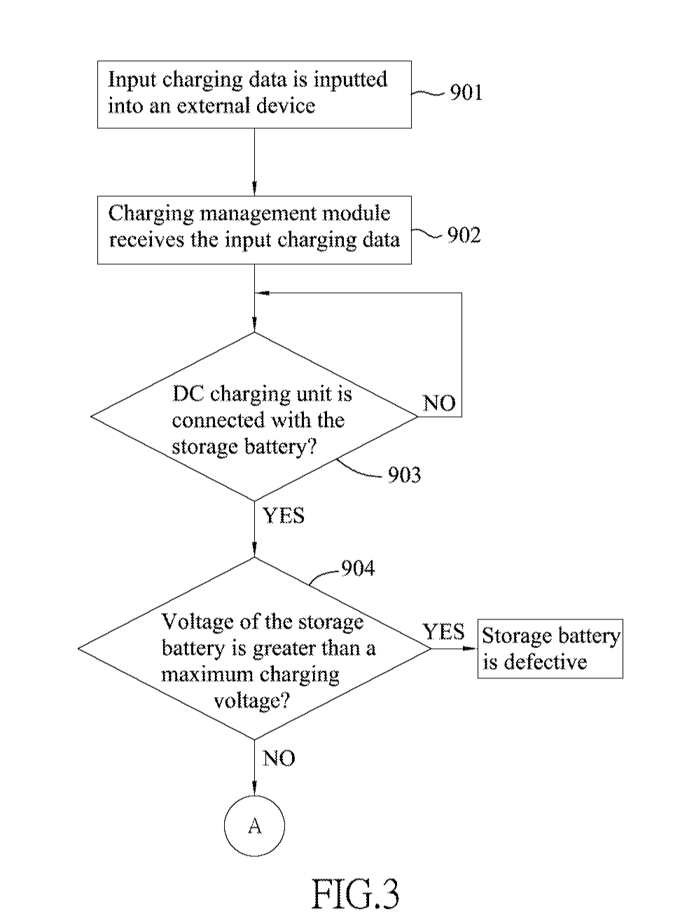

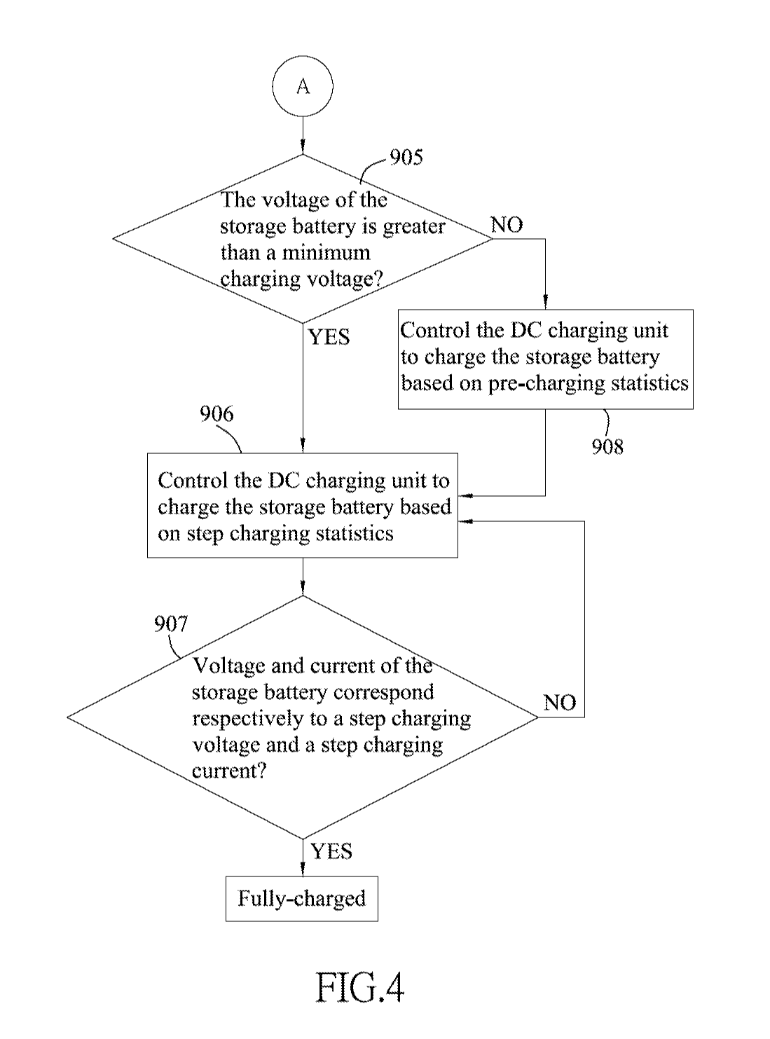

Referring to FIG. 2 to FIG. 4, in step 901, the input charging data that corresponds to the charging characteristic of the storage battery 2 is inputted by a user into the external device 33. The input charging data includes a set of charging upper-limit data, a set of pre-charging data, and a set of step charging data. For example, the charging upper-limit data include a maximum charging voltage (31.2V), a minimum charging voltage (2V), a maximum charging current (10 A), and a maximum charging capacity (22 Ah) and so forth. The set of pre-charging data include a pre-changing voltage (20V), a pre-charging current (0.1 A), a pre-charging time (5 min) and so forth. The set of step charging data include a step charging voltage (29.4V), a step charging current (7 A), a step charging time (90 min) and so forth.

Subsequently, in step 902, the processing unit 344 of the charging management module 34 receives the input charging data via the communication unit 341.

In step 903, the processing unit 344 determines whether the DC charging unit 343 is connected with the storage battery 2. When the processing unit 344 determines that the storage battery 2 is not connected, step 903 is repeated. When the processing unit 344 determines that the DC charging unit 343 is connected with the storage battery 2, the flow goes to step 904.

In step 904, the processing unit 344 determines whether the voltage of the storage battery 2 detected by the voltage detector unit 345 is greater than the maximum charging voltage. When the processing unit 344 determines that the voltage of the storage battery 2 is greater than the maximum charging voltage, this means that the storage battery 2 is defective. When the processing unit 344 determines that the voltage of the storage battery 2 is not greater than the maximum charging voltage, the flow goes to step 905.

In step 905, the processing unit 344 determines whether the voltage of the storage battery 2 is greater than the minimum charging voltage. When the processing unit 344 determines that the voltage of the storage battery 2 is greater than the minimum charging voltage, the flow goes to step 906. Otherwise, the flow goes to step 908.

In step 908, the processing unit 344, based on the pre-charging data of the input charging data received in step 902, controls the DC charging unit 343 to charge the storage battery 2 according to the pre-charging data. It is noted that, if the storage battery 2 is over-discharged or has not been used for a long time, the voltage thereof may be lower than the minimum charging voltage. Therefore, the processing unit 344 is configured to control the DC charging unit 343 to output a pre-charging current in a form of pulses, so as to ware up the storage battery 2. After waking up the storage battery 2, the flow goes to step 906.

In step 906, the processing unit 344, based on the step charging data of the input charging data received in step 902, controls the DC charging unit 343 to charge the storage battery 2 according to the step charging data.

In step 907, after the step charging time has passed, the processing unit 344 determines whether the voltage and the current of the storage battery 2 correspond to the step charging voltage and the step charging current, respectively. When the processing unit 344 determines that the voltage and the current correspond to the step charging voltage and the step charging current, respectively, this means that the storage battery 2 has been fully-charged. Otherwise, the flow goes back to step 906.

It is noted that since the memory unit 342 of the charging management module 34 is able to store the preset charging data, the processing unit 344 may directly access the preset charging data stored in the memory unit 342 without connecting to the external device 33 for receiving the input charging data. Therefore, the charging device 3 of the present invention may be disengaged from the external device 33 and operate independently.

To sum op, the communication unit 342 of the charging management module 34 receives the input charging data inputted through the external device 33, and the processing unit 344 receives the input charging data and, based on the input charging data, controls the DC charging unit 343 to generate the DC charging power that is used to charge the storage battery 2 and that conforms with the charging characteristic of the storage battery 2. In this way, the charging device 3 of the present invention is suitable for different kinds of storage batteries with distinct specifications. Moreover, since the memory unit 342 of the charging management module 34 may store the input charging data to serve as the preset charging data, when the charging device 3 is used to charge the same storage battery 2, the input charging data is not required to be inputted once again, so as to achieve convenient usage of the charging device 3.

While the present invention has beer; described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A charging device to be connected electrically to an alternating-current (AC) power source end configured to charge a storage battery, said charging device comprising:
a converter module which is to be connected electrically to the At power source and which converts an AC power received from the AC power source into a direct-current (DC) power; and
a charging management module which includes
a communication unit for data exchange with an external device,
a DC charging unit connected electrically to said converter module for receiving the DC power, and to be connected electrically to the storage battery,
a processing unit connected electrically to said communication unit and said DC charging unit, and receiving input charging data from the external device via said communication unit, and
a memory unit connected electrically to said processing unit and storing preset charging data;
wherein the input charging data and the preset charging data are associated with a charging characteristic of the storage battery; and
wherein said processing unit, based on one of the input charging data and the preset charging data, controls said DC charging unit to convert the DC power received thereby into a DC charging power that is used to charge the storage battery and that conforms with the charging characteristic of the storage battery.

2. The charging device according to claim 1, wherein said charging management module further includes a voltage detector unit which is connected electrically to said processing unit and which is to be connected electrically to the storage battery for detecting a voltage of the storage battery.

3. The charging device according to claim 2, wherein said processing unit makes a comparison between the voltage detected by said voltage detector unit and said one of the input charging data and the preset charging data, and controls said DC charging unit according to a result of the comparison made thereby.

4. The charging device according to claim 1, wherein said charging management module further includes a current detector unit which is connected electrically to said processing unit and which is to be connected electrically to the storage battery for detecting a current of the storage battery.

5. The charging device according to claim 4, wherein said processing unit makes a comparison between the current detected by said current detector unit and said one of the input charging data and the preset charging data, and controls said DC charging unit according to a result of the comparison made thereby.

6. The charging device according to claim 1, further comprising a casing that houses said converter module and said charging management module.

7. A charging device to be connected electrically to an alternating-current (AC) power source and configured to charge a storage battery, said charging device comprising:
a converter module which is to be connected electrically to the AC power source and which converts an AC power received from the AC power source into a direct-current (DC) power; and
a charging management module which includes
a communication unit for data exchange with an external device,
a DC charging unit connected electrically to said converter module for receiving the DC power, and to be connected electrically to the storage battery, and
a processing unit connected electrically to said communication unit and said DC charging unit, and receiving input charging data from the external device via said communication unit;
wherein the input charging data is associated with a charging characteristic of the storage battery; and
wherein said processing unit, based on the input-charging data, controls said DC charging unit to convert the DC power received thereby into a DC charging power that is used to charge the storage battery and that conforms with the charging characteristic of the storage battery.

8. The charging device according to claim 7, wherein said charging management module further includes a voltage detector unit which is connected electrically to said processing unit and which is to be connected electrically to the storage battery for detecting a voltage of the storage battery.

9. The charging device according to claim 8, wherein said processing unit makes a comparison between the voltage detected by said voltage detector unit and the input charging data, and controls said DC charging unit according to a result of the comparison made thereby.

10. The charging device according to claim 7, wherein said charging management module further includes a current detector unit which is connected electrically to said processing unit and which is to be connected electrically to the storage battery for detecting a current of the storage battery.

11. The charging device according to claim 10, wherein said processing unit makes a comparison between the current detected by said current detector unit and the input charging data, and controls said DC charging unit according to a result of the comparison made thereby.

12. A charging device to be connected electrically to an alternating-current (AC) power source and configured to charge a storage battery, said charging device comprising:
a converter module which is to be connected electrically to the AC power source and which converts an AC power received from the AC power source into a direct-current (DC) power; and
a charging management module which includes
a DC charging unit connected electrically to said converter module for receiving the DC power, and to be connected electrically to the storage battery,
a processing unit connected electrically to said DC charging unit, and
a memory unit connected electrically to said processing unit and storing preset charging data associated with a charging characteristic of the storage battery;
wherein said processing unit, based on the preset charging data, controls said DC charging unit to convert the DC power received thereby into a DC charging power that is used to charge the storage battery and that conforms with the charging characteristic of the storage battery.

13. The charging device according to claim 12, wherein said charging management module further includes a voltage defector unit which is connected electrically to said processing unit and which is to be connected electrically to the storage battery for detecting a voltage of the storage battery.

14. The charging device according to claim 13, wherein said processing unit makes a comparison between the voltage detected by said voltage detector unit and the preset charging data, and controls said DC charging unit according to a result of the comparison made thereby.

15. The charging device according to claim 12, wherein said charging management module further includes a current defector unit which is connected electrically to said processing unit and which is to be connected electrically to the storage battery for detecting a current of the storage battery.

16. The charging device according to claim 15, wherein said processing unit makes a comparison between the current detected by said current detector unit and the preset charging data, and controls said DC charging unit according to a result of the comparison made thereby.

17. The charging device according to claim 12, wherein said charging management module further includes a communication unit for data exchange with an external device, said processing unit being connected electrically to said communication unit to receive input charging data from the external device via said communication unit, said processing unit being configured to store the input charging data received thereby in said memory unit to serve as the preset charging data.
